(19) United States
(12) Patent Application Publication
(10) Pub. No.: US 2015/0156821 A1
(43) Pub. Date: Jun. 4, 2015

(54) HEATING ELEMENT FOR A PLASTIC-TUBE BUTT-WELDING MACHINE, METHOD FOR MANUFACTURING A PANEL-TYPE RADIATOR, AND PLASTIC-TUBE BUTT-WELDING MACHINE

(71) Applicants: MARTIN DOMMER, Ditzingen (DE); MICHAEL SCHMITT, Hausen bei Wuerzburg (DE)

(72) Inventors: MARTIN DOMMER, Ditzingen (DE); MICHAEL SCHMITT, Hausen bei Wuerzburg (DE)

(21) Appl. No.: 14/552,850

(22) Filed: Nov. 25, 2014

(30) Foreign Application Priority Data
Nov. 29, 2013 (DE) 10 2013 224 612.9

(51) Int. Cl. H05B 3/30; B32B 37/06; B23K 31/02

(52) U.S. Cl. CPC H05B 3/30; B23K 31/02; B32B 37/06

(57) ABSTRACT

Heating element for a plastic-tube butt-welding machine having a plate-type radiator in which at least one electric heat source is integrated.

The plate-type radiator includes a metallic foam structure in which at least one electric heat source is embedded in a heat-conducting manner.

### CROSS-REFERENCE TO RELATED APPLICATIONS

This application claims the priority of the German patent application DE 10 2013 224 612.9, the disclosure of which is hereby incorporated into this application.

### FIELD OF THE INVENTION

The invention relates to a heating element for a plastic-tube butt-welding machine having a panel-type radiator in which at least one electric heat source is integrated, and a method for manufacturing a panel-type radiator of such type, and a plastic-tube butt-welding machine having a heating element of such type.

### BACKGROUND OF THE INVENTION

A device for butt-welding plastic tubes is known from DE 10 2012 207 098 A1. The known device displays clamping tools for coaxially holding two plastic tubes which are to be welded together. Moreover, the welding device is provided with a plate-shaped heating element, the heating plate faces of which serve for plasticization of the end faces of the tube ends which face one another, in order to subsequently obtain the desired butt weld by pressing together the tube ends of the two plastic tubes. Prior to pressing together the tube ends, the plate-shaped heating element is removed again. The plate-shaped heating element is provided with an integrated electric heat source, in particular in the form of heating cartridges or in the form of an electric tubular heating element.

### SUMMARY OF THE INVENTION

It is an object of the invention to achieve a heating element and a plastic-tube butt-welding machine of the type mentioned at the outset which in terms of their energy efficiency and their ecological classification are improved in comparison to the prior art.

This object is achieved for the heating element in that the plate-type radiator comprises a metallic foam structure in which the at least one electric heat source is embedded in a heat-conducting manner. On account of the metallic foam structure, a significant weight reduction results for the plate-type radiator and thus inevitably for the heating element, such that the heating element can be manually handled by one operator. On account of the metallic foam structure, less energy than in the prior art is required for heating up the heating element, on the one hand. On the other hand, less energy is also required to maintain the heating element at a corresponding operating temperature. As a metallic foam structure, preferably a foam structure from an aluminum alloy is provided. It is also possible for the metallic foam structure to be manufactured from other metal alloys. The heating element according to the invention is advantageously employed in plastic-tube butt-welding machines in which, for welding the tube ends of adjacent plastic tubes, the end faces of the tube ends are heated and plasticized. The tube ends of the two plastic tubes are subsequently pressed against one another, on account of which, by way of the plasticized end faces, an encircling weld of the two tube ends and, consequently, connecting of the two plastic tubes results.

In an embodiment of the invention, the metallic foam structure, on its base areas lying opposite one another, is flanked in each case by one planar metal plate which is connected in a materially integral manner to the respective base area of the metallic foam structure. The two metal plates are two-dimensional across their entire area and are evenly connected to the correspondingly facing base area of the metallic foam structure in that said metal plates are cross-linked to the metallic foam structure during manufacturing.

In a further embodiment of the invention, the metallic foam structure and the two metal plates which flank the metallic foam structure display base areas which are identical to one another and, in the direction of a thickness of the plate-type radiator, are aligned with one another. On account thereof, a uniform plate-type radiator having peripheries of the metallic foam structure and of the metal plates adjoining on both sides, which terminate in a flush manner in relation to one another, results.

In a further embodiment of the invention, the electric heat source comprises at least one tubular radiator or at least one heating cartridge, enclosed in a form-fitting and/or materially integral manner by the metallic foam structure. On account thereof, good conduction of heat, which enables energy-saving heating up of the metallic foam structure by way of the electric heat source, results between the electric heat source and the metallic foam structure. The electric tubular radiator may display one or more tubular heating coils. Preferably, a plurality of heating cartridges which are distributed across the base area of the metallic foam structure are provided. The electric heat source is preferably designed in such a manner that an even heating up across the entire area of the metallic foam structure can be obtained.

In a further embodiment of the invention, the tubular radiator comprises at least one tubular heating coil which, in the metallic foam structure, runs in a plane which extends in a parallel manner between the metal plates. This enables even and energy-saving heating up of the metallic foam structure.

In a further embodiment of the invention, at least one temperature sensor protrudes into the metallic foam structure. Said temperature sensor serves for controlling or regulating the energy supply to the electric heat source.

In a further embodiment of the invention, a surface of each metal plate of the plate-type radiator is assigned a non-stick layer. On account thereof it is ensured that the outer sides of the heating element, during heating and plasticization of the end faces of the respective tube ends of the plastic tube, do not adhere to these end faces and that no damage to the tube ends due to plastic material correspondingly adhering to the heating element arises.

In a further embodiment of the invention, the non-stick layer is formed by a film covering which, while allowing an air gap, is disposed so as to be spaced apart from and in parallel with the surface of the respective metal plate. Between the film covering and the surface of the assigned metal plate of the heating element an air cushion which has an insulating and heat-storing effect for the heating faces of the heating element results. This means that less heat is dissipated from the heating faces of the plate-type radiator to the environment during operation of the heating element. This embodiment forms a further contribution toward saving electric heating energy. The film covering, by way of the adjacent heating face and the air gap lying in between, heats up to a corresponding plasticization temperature for the respective end face of the tube-end to be welded. The film covering, on its outer side facing the tube end, displays a non-stick face, such that it cannot adhere to the end face of the respectively assigned tube end.

In a further embodiment of the invention, the non-stick layer is formed by a coating which is applied on the surface of the metal plate. The non-stick coating which is directly applied on the surface of the respective metal plate may also develop a certain heat-storing effect which, however, is reduced in comparison to the heat-storing effect by way of the air cushion according to the embodiment described earlier.

It is also an object of the invention to provide a method of the type mentioned at the outset which, using simple means, enables manufacturing of a particularly energy-efficient heating element.

This object is achieved by the features of patent claim 10. Advantageously, after splitting the unit consisting of the metallic foam structure and the metal plates, that is to say after splitting the metal blank body, the electric heat source, for manufacturing the plate-type radiator, is inserted between the two halves of the blank body and impinged with a current. The electric heat source here is preferably heated up to a high temperature. Simultaneously, the two halves which, with their open metallic foam structure bear on the outer contours of the electric heat source, are impinged with pressure and with temperature from the metal plates lying opposite. Here, the metal plates are preferably heated from the outside with a temperature of approx. 400° C. In the case of the metallic foam structure being formed by an aluminum alloy, the inserted heat source is advantageously heated up to a temperature of about 600° C. On account thereof, the metallic foam structure, in the region of the outer contours of the electric heat source and in the region of the separation faces of the two halves, takes on a doughy consistency, on account of which said metallic foam structure fuses on the outer contours of the electric heat source, in particular on a corresponding tubular radiator, and wraps itself therearound. On account of the pressure exerted from the opposite sides, the metallic foam structure is simultaneously compressed in the immediate vicinity of the outer contours of the electric heat source, on account of which particular good conduction of heat results between the outer contours of the heat source and the metallic foam structure. Moreover, the faces of the open metallic foam structures of the two halves which face one another connect to one another in a materially integral manner across the entire base area of the heating element, such that a homogenous plate-type radiator having an integrated electric heat source results after cooling.

Manufacturing of the blank body, that is to say connecting the metal plates to the metallic foam structure, preferably takes place in a single-stage manufacturing process, wherein the base material for the metallic foam structure is provided with a propellant, by way of which the corresponding foam structure is created. The metal plates lying on the outside display no propellant. The foam structure, during manufacturing, inevitably clings in a materially integral manner to the metal plates lying on the outside, which are advantageously composed of the same metal alloy as the metallic foam structure.

In an embodiment of the method, an encircling peripheral region of the metallic foam structure is sealed so as to be watertight. On account thereof, it is ensured that the interior of the metallic foam structure is sealed against entry of humidity and water, such that no corrosion can arise.

The invention also relates to a plastic-tube butt-welding machine according to patent claim 13.

### BRIEF DESCRIPTION OF THE DRAWINGS

Further advantages and features of the invention are derived from the claims and from the following description of a preferred exemplary embodiment of the invention, which is illustrated by means of the drawings.

FIG. 1 in a perspective illustration, shows an embodiment of a plastic-tube butt-welding machine according to the invention having an embodiment of a heating element according to the invention;

FIG. 2 shows the heating element as per FIG. 1;

FIG. 3, in a schematic, enlarged cross-sectional illustration along the section line III-III, shows the heating element as per FIG. 2;

FIG. 4 shows an illustration of the heating element, similar to FIG. 2, but without invisible contours;

FIG. 5 shows the heating element as per FIGS. 2 to 4, in a perspective illustration in a longitudinal section;

FIGS. 6 to 9 show illustrations of various method steps for manufacturing a plate-type radiator of the heating element as per FIGS. 2 to 5; and

FIG. 10, in a cross section along the section line X-X in FIG. 8, shows the completed plate-type radiator.

### DETAILED DESCRIPTION

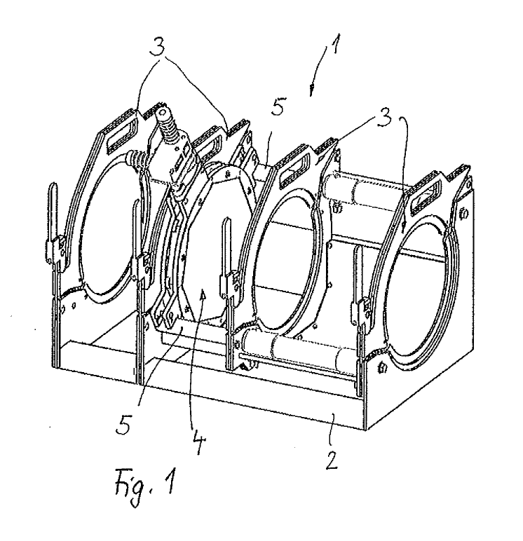

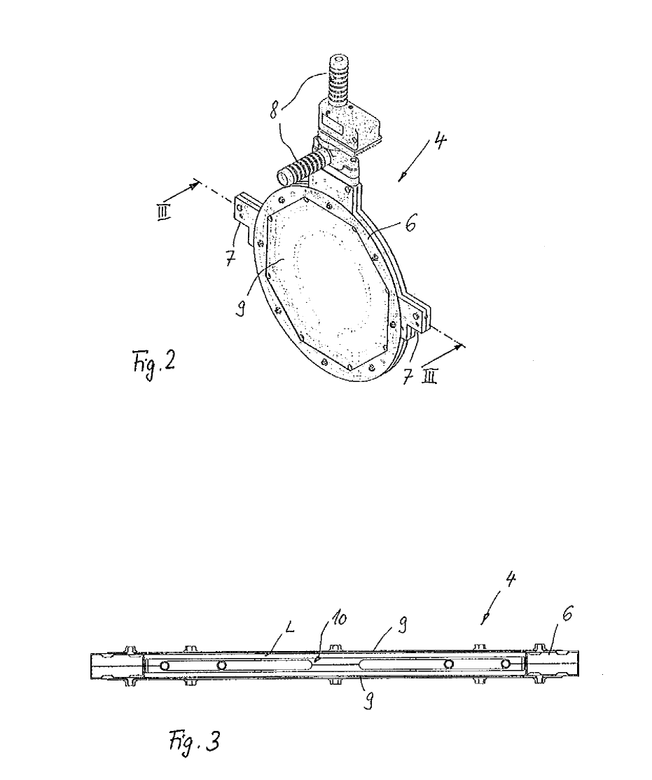

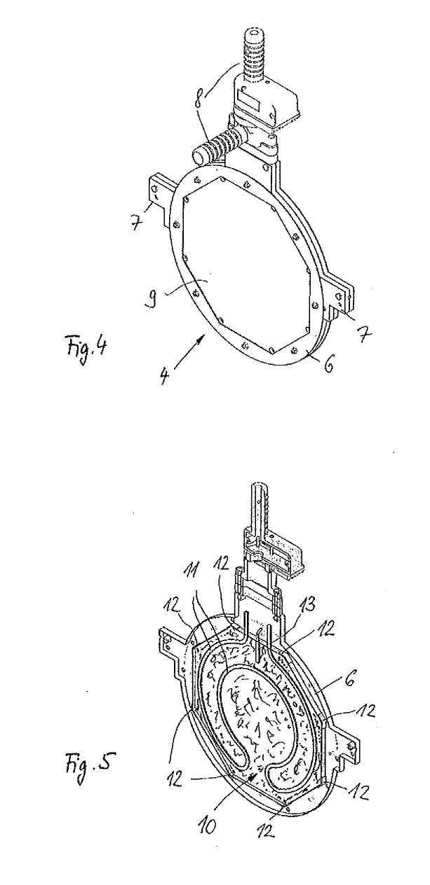

A welding machine 1 as per FIG. 1 serves for butt-welding plastic tubes, wherein in each case two plastic tubes, with their tube ends, are oriented so as to coaxially align with one another. The end faces of the adjacent tube ends are subsequently heated and plasticized. Then the tube ends are joined up against one another, on account of which they butt on one another and are welded together in an encircling manner in the region of the plasticized end faces.

The plastic-tube butt-welding machine 1, in a manner which is known in principle, displays a support frame 2 on which a plurality of clamping tools 3 for receiving and fixing the plastic tubes are held. The two clamping tools illustrated on the left in FIG. 1 are disposed in a stationary manner on the support frame 2. The two right clamping tools 3 may be axially displaced by means of hydraulic cylinders, in order to enable the mutual guiding together of the plastic tubes.

For plasticization of the face ends of the tube ends, a heating element 4 which may be manually removed from the support frame 2 is provided. Two rails 5 of the support frame 2, which run in an axial manner, serve for mounting and positioning of the heating element 4. To this end, the heating element 4, on sides lying opposite one another, displays corresponding support jaws 7 which serve for supporting the heating element 4 on the rails 5.

The heating element 4 displays a receiving frame 6 in which a plate-type radiator 10 which will be described in more detail in the following is held. The plate-type radiator 10 comprises an electric heat source in the form of a tubular heating coil 11 which is embedded in a plate-type radiator 10. A temperature sensor 13 is likewise integrated in the plate-type radiator 10. The plate-type radiator 10 displays a regular octagonal base area. The plate-type radiator 10 is held within the frame 6 by a plurality of support lugs 12 in the region of the corners of the plate-type radiator 10.

The plate-type radiator 10, on its outer sides lying opposite one another, displays in each case an octagonal metal plate M which is manufactured from an aluminum alloy. A base structure of the plate-type radiator 10, between the metal plates M which lie opposite one another, is formed by a metallic foam structure S which encloses the electric heat source in the form of a tubular heating coil 11 in the manner which is described in more detail in the following. The metallic foam structure S is also manufactured from an aluminum alloy.

Moreover, the heating element 4, on both sides, is in each case provided with a film covering 9 which is chucked in the frame 6. According to FIG. 3, the film covering 9 is disposed at a slight parallel distance from the respective metal plate M of the plate-type radiator 10. On account thereof, an air gap L which extends across the entire surface of the respective metal plate M results between an inner side of the respective film covering 9 and a corresponding surface of the respective metal plate M, such that an air cushion which has the effect of heat storage and insulation functions during heating up and maintaining heat of the heating element 4 results between the film covering 9 and the plate-type radiator 10 on the sides of the plate-type radiator 10 which lie opposite one another. The film covering 9, at least toward the outside, forms a non-stick face in order to prevent that plastic material of the correspondingly plasticized end face of the respective tube end adheres to the film covering 9. The film covering 9 may be flexible, such that it bears on the surface of the metal plate M when the heating element 4 is pressed against a corresponding end face of the tube end to be heated. For this purpose, the film covering 9 is so heat resistant that it is not damaged by bearing on the surface of the heated-up plate-type radiator 10, that is to say on the surface of the respective metal plate M.

For manufacturing the plate-type radiator 10, initially an octagonal blank body or base body R is created from the two metal plates M lying opposite one another and a metallic foam structure S which is situated therebetween in a materially integral manner. In the case of the illustrated exemplary embodiment, the metallic foam structure S is made from an aluminum alloy and manufactured using a suitable propellant and cross-linked in a two-dimensional manner across the entire base area of the base body R with the metal plates M which are likewise manufactured from corresponding aluminum alloys. A thickness of the base body R, including the thickness of the metal plates M and the thickness of the metallic foam structure S, is somewhat larger than the later thickness of the completed plate-type radiator 10 (see FIG. 10).

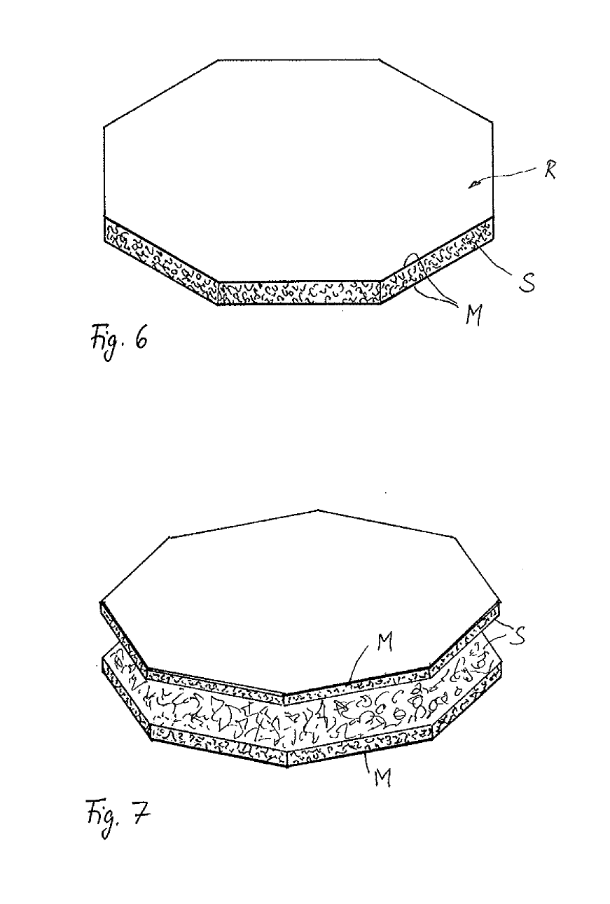

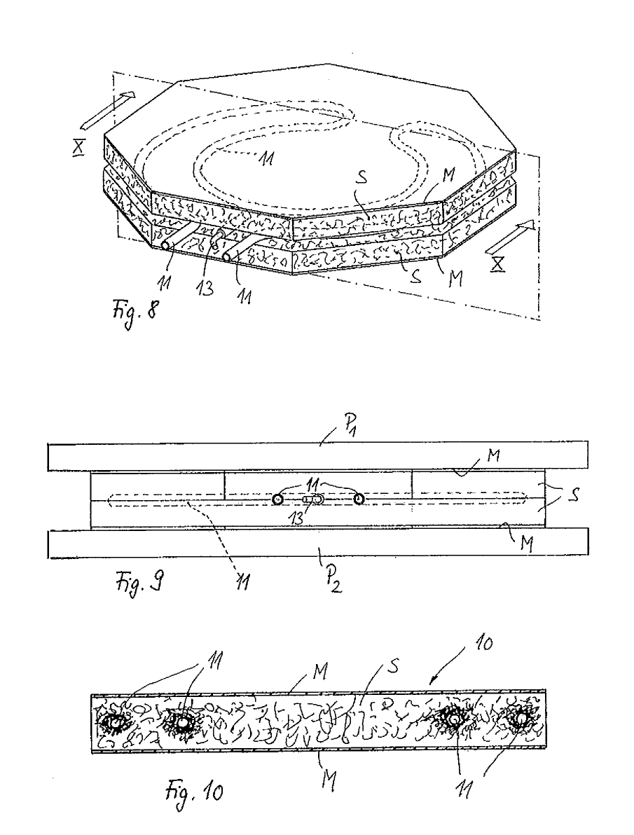

This base body R is cut in a subsequent method step along a section plane which is parallel to the base areas of the metal plates M, such that two base-body halves which are at least largely of the same thickness and severed from one another result (see FIG. 7).

According to FIG. 8, the electric heat source, presently in the form of the tubular heating coil 11, is subsequently inserted between the two halves of the base body R. Moreover, the temperature sensor 13 is inserted into its corresponding position between the two halves. This method step is evident by means of FIG. 8. The electric heat source in the form of the tubular heating coil 11 is connected to an electric circuit and heated up to about 600° C. Prior thereto, the unit consisting of the two halves of the base body R, the tubular heating coil 11, and the temperature sensor 13, was placed between two pressing tools P1, P2. The corresponding heading tools P1, P2 are moreover impinged with temperature, in that they are heated up to about 400° C. On account of the heating temperature of the tubular heating coil 11 which extends across the entire base area of the metal plates M of about 600° C. and of the temperature of about 400° C. which is applied from both sides to the metal plates M, in conjunction with the pressure brought to bear from both sides via the pressing tools Pl, P2, the two halves of the base body, with their open metallic foam structure S which bears from above or from below, respectively, on the tubular heating coil 11, are pressed against said tubular heating coil 11, such that the tubular heating coil 11 is squeezed, sandwich-like, in between the two halves. On account of the high temperatures in the region of the tubular heating coil 11 and in the region of the metal plates M, and of the heating introduced by heat conduction also into the metallic foam structure S, the metallic foam structure S, particularly in the region of the separation plane, that is to say the positioning plane of the tubular heating coil 11, becomes doughy, on account of which the material of the metallic foam structure readily cross-links with the surface of the tubular heating coil 11, that is to say with the outer contour thereof, and compresses in the region of the tubular heating coil 11 and wraps itself therearound. The compression of the metallic foam structure S in the region of the contours of the tubular heating coil 11 is schematically illustrated by means of FIG. 10. Simultaneously, the separation faces of the metallic foam structure S of the upper half and the lower half of the severed base body R, which face one another, fuse with one another, such that the plate-type radiator 10 which is of uniform material across the entire thickness results. The two halves are henceforth fixedly connected to one another across the entire base area and enclose the tubular heating coil 11 and the temperature sensor 13 in a materially integral manner. The plate-type radiator 10 thus formed ensures very good heat conduction between the outer walls of the tubular heating coil 11 and the metallic foam structure S. On account thereof, good heating up of the plate-type radiator 10 and maintaining an even temperature is ensured despite a relatively low investment of energy. Moreover, on account of the metallic foam structure S, the weight of the plate-type radiator 10 is significantly reduced in comparison to a plate-type radiator made from a solid material, on account of which manageability of the plate-type radiator 10 and of a plate-shaped heating element 4 provided with the plate-type radiator 10 for a corresponding operator is significantly simplified.

After cooling, the plate-type radiator 10, on its encircling peripheral region which shows the open metallic foam structure S, is sealed so as to be watertight.

1. A heating element for a plastic-tube butt-welding machine having a plate-type radiator in which at least one electric heat source is integrated, wherein the plate-type radiator comprises a metallic foam structure in which the at least one electric heat source is embedded in a heat-conducting manner.

2. The heating element as claimed in claim 1, wherein the metallic foam structure, on its base areas lying opposite one another, is flanked in each case by one planar metal plate which is connected in a materially integral manner to the metallic foam structure.

3. The heating element as claimed in claim 1, wherein the metallic foam structure and the two metal plates which flank the metallic foam structure display base areas which are identical to one another and, in the direction of a thickness of the plate-type radiator, are aligned with one another.

4. The heating element as claimed in claim 1, wherein the electric heat source comprises at least one tubular heating coil or at least one heating cartridge, enclosed in a form-fitting and/or materially integral manner by the metallic foam structure.

5. The heating element as claimed in claim 4, wherein the at least one tubular heating coil, in the metallic foam structure, runs in a plane which extends in a parallel manner between the metal plates.

6. The heating element as claimed in claim 4, wherein at least one temperature sensor protrudes into the metallic foam structure.

7. The heating element as claimed in claim 1, wherein a surface of each metal plate of the plate-type radiator is assigned a non-stick layer.

8. The heating element as claimed in claim 7, wherein the non-stick layer is formed by a film covering which, while allowing an air gap, is disposed so as to be spaced apart from and in parallel with the surface of the respective metal plate.

9. The heating element as claimed in claim 7, wherein the non-stick layer is formed by a non-stick coating which is applied on the surface of the metal plate.

10. A method for manufacturing a plate-type radiator for a heating element as claimed in claim 1, wherein a plate-type metallic foam structure, on its end faces lying opposite one another, is connected in a materially integral manner to two metal plates which are parallel to one another, wherein subsequently the unit consisting of the metallic foam structure and the metal plates, in a sectional plane which runs parallel between the metal plates, is severed into two halves, wherein subsequently an electric heat source in the form of at least one tubular heating coil or at least one heating cartridge is inserted between the two halves, and wherein finally the two halves are impinged in such a manner with pressure and temperature that the two halves, on their separation faces, connect to one another in a materially integral manner and embed the electric heat source between them.

11. The method as claimed in claim 10, wherein the electric heat source, after insertion between the two halves, is heated to a temperature which corresponds to a plasticization temperature for the metallic foam structure.

12. The method as claimed in claim 10, wherein an encircling peripheral region of the metallic foam structure is sealed so as to be watertight.

13. A plastic-tube butt-welding machine having at least one heating element which is designed as claimed in claim 1.
